(19) United States
(12) Patent Application Publication
(10) Pub. No.: US 2007/0064370 A1
(43) Pub. Date: Mar. 22, 2007

(54) Semiconductor integrated circuit device, power supply apparatus, and electric appliance

(76) Inventor: Yoichi Kajiwara, Kyoto-shi (JP)

Correspondence Address: FISH & RICHARDSON P.C., P.O. BOX 1022, MINNEAPOLIS, MN, 55440-1022, US

(21) Appl. No.: 11/521,975

(22) Filed: Sep. 14, 2006

(30) Foreign Application Priority Data
Sep. 16, 2005 (JP) 2005-269503

(51) Int. Cl. H02H 5/04

(52) U.S. Cl. 361/103

(57) ABSTRACT

A semiconductor integrated circuit device of the present invention is provided with: first and second external terminals, each of which receives a corresponding one of two different potentials applied thereto; first and second switches that are connected in series between the first and second external terminals and connected together at a node from which an output signal is extracted; a heat generation detector portion for detecting a monitored temperature; and a drive circuit for performing on/off control of the first and second switches. When the monitored temperature reaches a first threshold temperature, both the first and second switches are turned off, and, when the monitored temperature reaches a second threshold temperature that is higher than the first threshold temperature, the first and second external terminals are short-circuited so as to operate an overcurrent protection element connected externally. With this configuration, it is possible to perform by inexpensive means an overheat protection operation that offers a higher level of safety.

This application is based on Japanese Patent Application No. 2005-269503 filed on Sep. 16, 2005, the contents of which are hereby incorporated by reference.

### BACKGROUND OF THE INVENTION

1. Field of the Invention

The present invention relates to a semiconductor integrated circuit device having an overheat protection circuit, and a power supply apparatus and an electric appliance provided with such a semiconductor integrated circuit device, more particularly, to improvement of an overheat protection function thereof.

2. Description of Related Art

Conventionally, many semiconductor integrated circuit devices (hereinafter “ICs (integrated circuits)”) such as power supply apparatuses or motor drive units that drive a power transistor have a built-in overheat protection circuit (a so-called thermal shutdown circuit) as means for preventing a breakdown of the IC (especially a breakdown of the power transistor that generates heat) due to abnormal generation of heat of the power transistor (see, for example, JP-A-2004-253936 and JP-B-06-016540, which the applicant of the present invention once filed).

It is true that the aforementioned conventional IC built with an overheat protection circuit can prevent a breakdown of the IC by detecting abnormal heat generation of the IC resulting from malfunction or overload and then reducing heat generation.

However, the conventional technique disclosed in JP-A-2004-253936 merely stops driving of the power transistor when a chip temperature reaches a threshold temperature, leaving a current supply path to the power transistor in a conduction state. Thus, if the overheat protection function described above fails to work properly for some causes after driving of the power transistor is stopped, and then driving of the power transistor is unintentionally resumed (for example, if the IC suffers from continuous abnormal temperature rises for some external causes, and thereby exhibits thermal runaway), overcurrent flows continuously until the power transistor breaks down. This may result in abnormal heat generation or breakdown of the IC itself or the circuits surrounding it. At worst, it may lead to serious accidents such as smoking or ignition.

Incidentally, the conventional technique disclosed in JP-B-06-016540 has an overheat protection function of stopping driving of the power transistor when a chip temperature reaches a first threshold temperature, and, if the chip temperature further increases and reaches a second threshold temperature, intentionally breaks the power transistor so as to change a current path into a fully-opened state. It is true that the aforementioned conventional technique can prevent the spread of damage to the circuits surrounding the IC and serious accidents such as fire by preventing thermal runaway of the IC. However, in this conventional technique, after preventing the thermal runaway of the IC by an intentional breakdown thereof, it is necessary to discard the broken IC and replace it with a new IC at the time of restoration of the device. This results in a lossy overheat protection means in terms of the cost and work except in cases where something is wrong with the IC itself.

### SUMMARY OF THE INVENTION

In view of the conventionally experienced problems described above, it is an object of the present invention to provide a semiconductor integrated circuit device that can perform by inexpensive means an overheat protection operation that offers a higher level of safety, and to provide a power supply apparatus and an electric appliance provided with such a semiconductor integrated circuit device.

To achieve the above object, according to the present invention, a semiconductor integrated circuit device is provided with: first and second external terminals, each of which receives a corresponding one of two different potentials applied thereto; first and second switches that are connected in series between the first and second external terminals and connected together at a node from which an output signal is extracted; a heat generation detector portion for detecting a monitored temperature; and a drive circuit for performing on/off control of the first and second switches. When the monitored temperature reaches a first threshold temperature, both the first and second switches are turned off, and, when the monitored temperature reaches a second threshold temperature that is higher than the first threshold temperature, the first and second external terminals are short-circuited.

### BRIEF DESCRIPTION OF THE DRAWINGS

FIG. 1 is a block diagram showing a first embodiment of a power supply IC of the present invention;

FIG. 2 is a block diagram showing a second embodiment of a power supply IC of the present invention;

FIG. 3 is a graph showing the correlation between resistance value and temperature of a positive characteristic thermistor;

FIG. 4 is a block diagram showing a third embodiment of a power supply IC of the present invention; and

FIG. 5 is a block diagram showing an example of application of the present invention to a motor driver IC.

### DETAILED DESCRIPTION OF PREFERRED EMBODIMENTS

Hereinafter, a switching power supply IC will be described in detail as an example of a semiconductor integrated circuit device of the present invention.

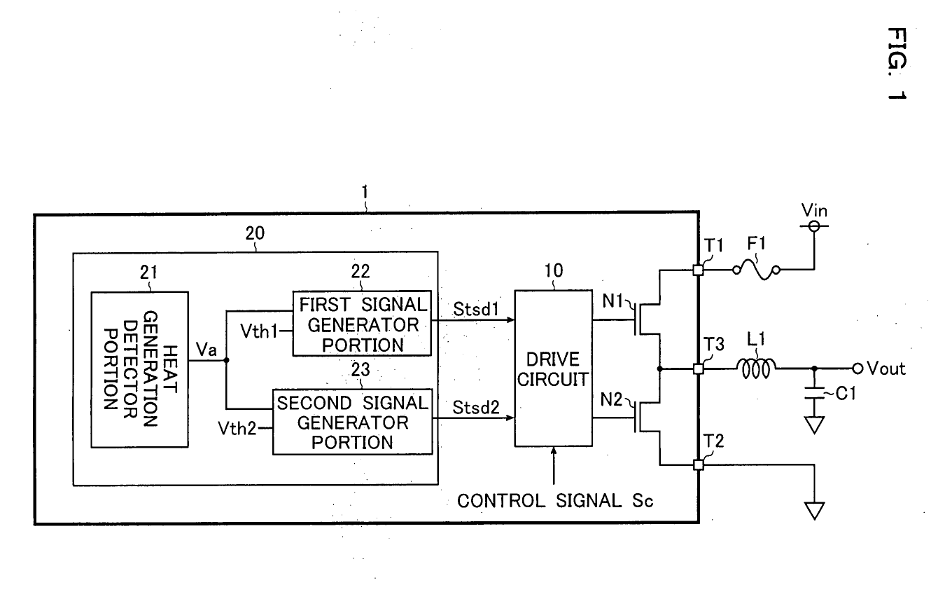

FIG. 1 is a block diagram showing a first embodiment of a switching power supply IC of the present invention. As shown in FIG. 1, a switching power supply IC 1 of this embodiment incorporates, as circuit blocks thereof, N-channel field-effect transistors N1 and N2, a drive circuit 10, and an overheat protection circuit 20, and has external terminals T1 to T3 through which the switching power supply IC is electrically connected to the outside.

The drain of the transistor N1 is connected to the external terminal T1 (an input terminal). The source of the transistor N1 is connected to the external terminal T3 (an output terminal) and to the drain of the transistor N2. The source of the transistor N2 is connected to the external terminal T2 (a ground terminal). The gates of the transistors N1 and N2 are individually connected to the control signal output terminals of the drive circuit 10.

Outside the switching power supply IC 1, the external terminal T1 is connected, via an overcurrent protection element (a fuse F1), to a power supply line to which an input voltage Vin is applied. The external terminal T2 is grounded. The external terminal T3 is connected to one end of an inductor L1. The other end of the inductor L1 is connected to a terminal (a power input terminal for a load) from which an output voltage Vout is extracted, and is grounded via a capacitor C1.

That is, the transistors N1 and N2 are connected in series between the external terminals T1 and T2 to which two different potentials (Vin/GND)) are respectively applied, and correspond to first and second switch means connected together at a node from which an output signal is extracted.

The drive circuit 10 is means for turning on and off the transistors N1 and N2 complementarily according to a predetermined control signal Sc in obtaining an output voltage Vout from an input voltage Vin. Such push-pull driving is repeatedly performed, whereby the load is fed with an output voltage Vout that has been smoothed by the LC filter (the inductor L1 and the capacitor C1).

It should be understood that the term “complementarily” used in this specification covers not only cases where the turning on and off of the transistor N1 takes place exactly oppositely to that of the transistor N2 but also cases where, from the perspective of preventing a through current, the turning on and off of the transistor N1 takes place oppositely to but with a predetermined delay relative to that of the transistor N2.

Incidentally, the control signal Sc described above is a feedback signal or the like used for setting the duty factor of the on/off periods of the transistors N1 and N2 in such a way that the output voltage Vout takes a target value.

The overheat protection circuit 20 is built with: a heat generation detector portion 21 that generates a heat generation detection voltage Va whose voltage level varies according to a monitored temperature Tj; a first shutdown signal generator portion 22 that compares the heat generation detection voltage Va with a first threshold voltage Vth1 and then generates a first shutdown signal Stsd1 based on the comparison result; and a second shutdown signal generator portion 23 that compares the heat generation detection voltage Va with a second threshold voltage Vth2 and then generates a second shutdown signal Stsd2 based on the comparison result.

The heat generation detector portion 21 is so configured as to extract a voltage signal Va for heat generation detection (a voltage signal whose voltage level decreases with an increase in monitored temperature Tj) by exploiting a characteristic (for example, a negative temperature characteristic of about −2 (mV/° C.)) that a base-emitter forward voltage drop of a bipolar transistor or a forward voltage drop of a diode varies depending on ambient temperature.

The first shutdown signal generator portion 22 is means for generating a first comparison signal whose output logic changes in accordance with whether or not the heat generation detection voltage Va is higher than the first threshold voltage Vth1, and then sending the resultant first comparison signal to the drive circuit 10 as a first shutdown signal Stsd1. The first threshold voltage Vth1 is a direct-current voltage (for example, a band gap voltage) having a flat temperature characteristic, and has a voltage value corresponding to a first threshold temperature Tth1 of, for example, 175° C. Thus, the first shutdown signal Stsd1 is a binary signal that is enabled (for example, takes a high level) when the monitored temperature Tj is higher than the first threshold temperature Tth1, and is disabled (for example, takes a low level) when the monitored temperature Tj is lower than the first threshold temperature Tth1.

The second shutdown signal generator portion 23 is means for generating a second comparison signal whose output logic changes in accordance with whether or not the heat generation detection voltage Va is higher than the second threshold voltage Vth2 (<Vth1), and then sending the resultant second comparison signal to the drive circuit 10 as a second shutdown signal Stsd2. As is the case with the first threshold voltage Vth1, the second threshold voltage Vth2 is a direct-current voltage (for example, a band gap voltage) having a flat temperature characteristic, and has a voltage value corresponding to a second threshold temperature Tth2 (>Tth1) of, for example, 200° C. Thus, the second shutdown signal Stsd2 is a binary signal that is enabled (for example, takes a high level) when the monitored temperature Tj is higher than the second threshold temperature Tth2, and is disabled (for example, takes a low level) when the monitored temperature Tj is lower than the second threshold temperature Tth2.

The overheat protection circuit 20 (especially the heat generation detector portion 21 thereof) is provided near the transistors N1 and N2. Adopting this layout makes it possible to directly detect a junction temperature of the transistors N1 and N2 that generate heat, and thereby helps realize an overheat protection operation with a high degree of accuracy.

Incidentally, the overheat protection circuit 20 is of an automatic recovery type having hysteresis between the first and second threshold temperatures Tth1 and Tth2. With this configuration, it becomes possible to automatically recover the operation of the switching power supply IC 1 quickly when a chip temperature drops without waiting for an external recovery signal or the like. Moreover, adopting this configuration makes it possible to suppress logic oscillation of the first and second shutdown signals Stsd1 and Stsd2.

Upon receiving the first shutdown signal Stsd1 from the overheat protection circuit 20, the drive circuit 10 recognizes whether or not the monitored temperature Tj has reached the first threshold temperature Tth1 in accordance with whether the first shutdown signal Stsd1 is enabled or disabled, and controls whether or not to drive the transistors N1 and N2. More specifically, if the monitored temperature Tj is recognized as not having reached the first threshold temperature Tth1, the drive circuit 10 complementarily turns on and off the transistors N1 and N2, as usual, according to the control signal Sc. On the other hand, if the monitored temperature Tj is recognized as having reached the first threshold temperature Tth1, the drive circuit 10 turns off both the transistors N1 and N2 irrespective of the control signal Sc.

Such an overheat protection operation (the forced shutdown of the transistors N1 and N2) makes it possible, in a case where abnormal heat generation is caused by an internal failure of the switching power supply IC 1, to prevent subsequent rise in temperature. Thus, it becomes possible to prevent a breakdown of the switching power supply IC 1 (especially a breakdown of the transistors N1 and N2) due to abnormal heat generation.

On the other hand, upon receiving the second shutdown signal Stsd2 from the overheat protection circuit 20, the drive circuit 10 recognizes, in addition to performing the aforementioned overheat protection operation based on the first shutdown signal Stsd1, whether or not the monitored temperature Tj has reached the second threshold temperature Tth2, and controls whether or not to simultaneously turn on the transistors N1 and N2. More specifically, after the transistors N1 and N2 are forcedly shut down, if the monitored temperature Tj is recognized as not having reached the second threshold temperature Tth2, the drive circuit 10 judges that there is no need to cut off a current path to the external terminal T1, whereby the transistors N1 and N2 are held in the off state. On the other hand, if the monitored temperature Tj is recognized as having reached the second threshold temperature Tth2, the drive circuit 10 judges that the switching power supply IC 1 suffers from continuous abnormal temperature rises for some external causes and, if nothing is done, the switching power supply IC 1 may exhibit thermal runaway. Therefore, the drive circuit 10 turns on the transistors N1 and N2 irrespective of the control signal Sc and the first shutdown signal Stsd.

If there are continuous abnormal temperature rises even after forced shutdown of the transistors N1 and N2, the overheat protection operation described above (the simultaneous turning on of the transistors N1 and N2) is performed, whereby the external terminals T1 and T2 (i.e. the power supply and the ground) are intentionally short-circuited to feed an overcurrent through the current path and cause intentional blowout of the fuse F1. As a result, the current path to the transistors N1 and N2 is completely cut off. This makes it possible, even when the switching power supply IC 1 suffers from continuous abnormal temperature rises for some external causes after forced shutdown of the transistors N1 and N2, to prevent thermal runaway of the switching power supply IC 1 and thereby prevent the spread of damage to the circuits surrounding the IC and serious accidents such as fire.

Unlike the conventional configuration in which a current path is cut off by intentionally breaking a power transistor, with the switching power supply IC 1 configured as described above, it is possible to cut off the current path by causing intentional blowout of the external fuse F1. After completion of repair of the areas of abnormal heat generation, it is possible to restore the failed device only by replacement of an inexpensive fuse without replacing the switching power supply IC 1 with a new one. Thus, as compared to the conventional configuration described above, this makes it possible to achieve a reasonable overheat protection means in terms of the cost and work it requires.

In view of the deterioration in characteristics of the transistors N1 and N2 caused by intentional overcurrent, it is preferable that the duration for which the overcurrent is fed (the time taken for blowout of the fuse F1) be as short as possible. It is for this reason that, as the fuse F1, a fuse having the best possible thermal response should be selected.

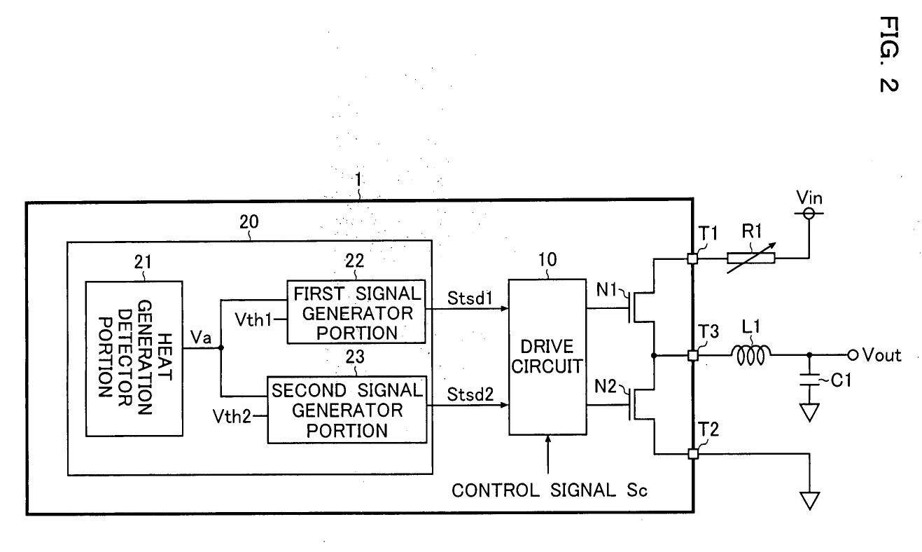

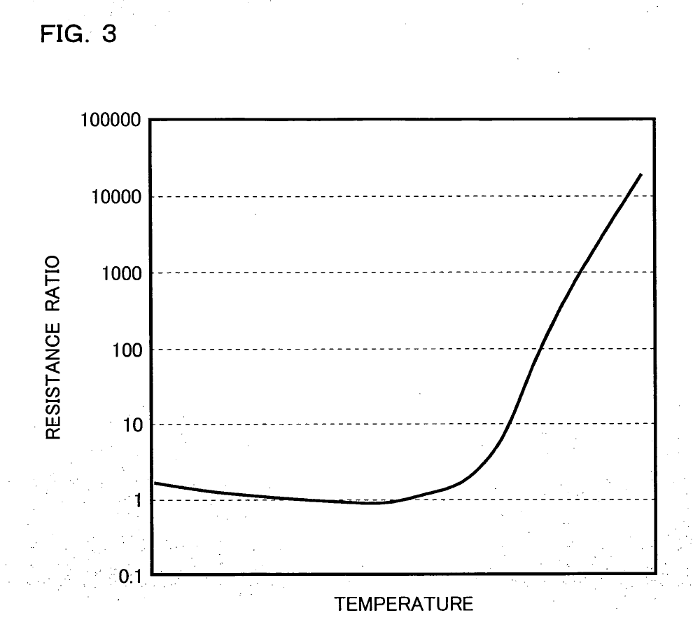

As an overcurrent protection element, a positive characteristic thermistor R1 (see a second embodiment shown in FIG. 2) may be used instead of the fuse F1. Here, the positive characteristic thermistor is an electronic device whose resistance value characteristically rises sharply at a certain temperature, as shown in FIG. 3. Such a positive characteristic thermistor can be formed by using, for example, ceramic obtained by adding a trace amount of rare earth to barium titanate and then sintering the resultant product. When the monitored temperature Tj reaches the second threshold temperature Tth2, the impedance of the positive characteristic thermistor R1 increases with an increase in device temperature resulting from an intentional overcurrent. Thus, as is the case where the fuse F1 is used, the use of such a positive characteristic thermistor R1 makes it possible to cut off the current path. On the other hand, after completion of repair of the areas of abnormal heat generation, the impedance of the positive characteristic thermistor R1 decreases as the device temperature decreases, making it possible to reestablish the current path. This eliminates even the need to replace the fuse, making it possible to achieve a further reasonable overheat protection means as compared with the first embodiment described above.

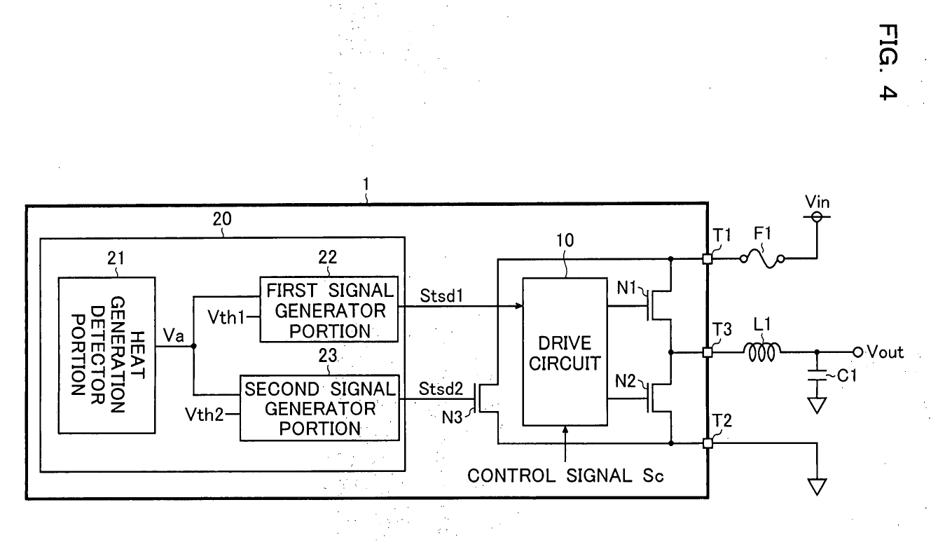

As means for short-circuiting the external terminals T1 and T2, instead of the aforementioned configuration in which the transistors N1 and N2 are simultaneously turned on, the following configuration may be adopted. An N-channel field-effect transistor N3 (third switch means) connected in parallel with the transistors N1 and N2 between the external terminals T1 and T2 is provided so that, when the monitored temperature Tj reaches the second threshold temperature Tth2, the transistor N3 is turned on if the second shutdown signal Stsd2 is enabled (see a third embodiment shown in FIG. 4). With this configuration, at the time of blowout of the fuse F1, an intentional overcurrent does not flow through the transistors N1 and N2. This prevents deterioration in characteristics of the transistors N1 and N2.

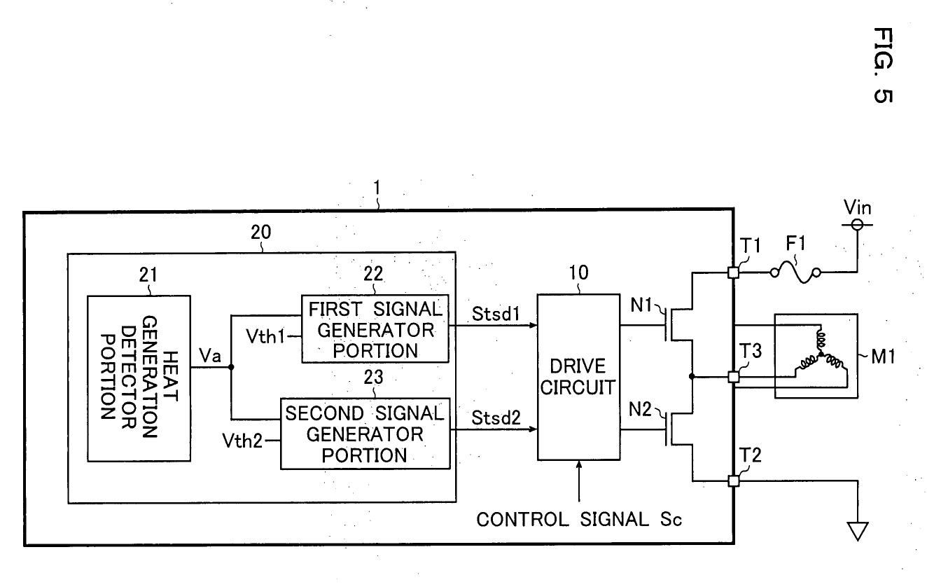

The embodiments described above deal with cases where the present invention is applied to a switching power supply IC. It is to be understood, however, that the present invention finds wide application in other semiconductor integrated circuit devices such as motor driver ICs (see FIG. 5).

It is to be understood that the present invention may be practiced in any other manner than specifically described above as embodiments, and various modifications are possible within the scope of the invention.

For example, as a power transistor, a P-channel field-effect transistor may be used instead of an N-channel field-effect transistor. Alternatively, a PNP or NPN bipolar transistor may be used instead.

According to a semiconductor integrated circuit device of the present invention, it is possible to perform by inexpensive means an overheat protection operation that offers a higher level of safety. Consequently, it is possible to enhance the safety of a power supply apparatus and an electric appliance provided with such a semiconductor integrated circuit device.

The present invention is a useful technique in enhancing the safety of a semiconductor integrated circuit device against abnormal heat generation. For example, the present invention can be suitably applied to switching power supply apparatuses or motor drive units built with an IC incorporating a power transistor.

What is claimed is:

1. A semiconductor integrated circuit device comprising:
first and second external terminals, each of which receives a corresponding one of two different potentials applied thereto;
first and second switches that are connected in series between the first and second external terminals and connected together at a node from which an output signal is extracted;
a heat generation detector portion for detecting a monitored temperature; and
a drive circuit for performing on/off control of the first and second switches, wherein
when the monitored temperature reaches a first threshold temperature, both the first and second switches are turned off, and, when the monitored temperature reaches a second threshold temperature that is higher than the first threshold temperature, the first and second external terminals are short-circuited.

2. The semiconductor integrated circuit device of claim 1, wherein
the drive circuit complementarily turns on and off the first and second switches according to a predetermined control signal when the monitored temperature does not reach the first threshold temperature, turns off both the first and second switches irrespective of the control signal when the monitored temperature reaches the first threshold temperature, and turns on both the first and second switches irrespective of the control signal when the monitored temperature reaches the second threshold temperature that is higher than the first threshold temperature.

3. The semiconductor integrated circuit device of claim 2, further comprising:
a first shutdown signal generator portion for comparing a heat generation detection voltage generated by the heat generation detector portion with a first threshold voltage, and then generating a first shutdown signal based on the comparison result; and
a second shutdown signal generator portion for comparing the heat generation detection voltage with a second threshold voltage, and then generating a second shutdown signal based on the comparison result, wherein
the drive circuit recognizes whether or not the monitored temperature has reached the first threshold temperature according to the first shutdown signal, and recognizes whether or not the monitored temperature has reached the second threshold temperature according to the second shutdown signal.

4. The semiconductor integrated circuit device of claim 1, further comprising:
a third switch connected in parallel with the first and second switches between the first and second external terminals, wherein
the drive circuit complementarily turns on and off the first and second switches according to a predetermined control signal when the monitored temperature does not reach the first threshold temperature, and turns off both the first and second switches irrespective of the control signal when the monitored temperature reaches the first threshold temperature, and
the third switch is turned on when the monitored temperature reaches the second threshold temperature that is higher than the first threshold temperature.

5. The semiconductor integrated circuit device of claim 4, further comprising:
a first shutdown signal generator portion for comparing a heat generation detection voltage generated by the heat generation detector portion with a first threshold voltage, and then generating a first shutdown signal based on the comparison result; and
a second shutdown signal generator portion for comparing the heat generation detection voltage with a second threshold voltage, and then generating a second shutdown signal based on the comparison result, wherein
the drive circuit recognizes whether or not the monitored temperature has reached the first threshold temperature according to the first shutdown signal, and
the third switch recognizes whether or not the monitored temperature has reached the second threshold temperature according to the second shutdown signal.

6. The semiconductor integrated circuit device of claim 1, wherein
at least one of the first and second external terminals is a terminal to which a predetermined potential is applied via an overcurrent protection element.

7. The semiconductor integrated circuit device of claim 6, wherein
the overcurrent protection element is a fuse or a positive characteristic thermistor.

8. A power supply apparatus comprising:
a semiconductor integrated circuit device;
a voltage converter portion for generating an output voltage from an input voltage by using the semiconductor integrated circuit device; and
an overcurrent protection element externally connected to at least one of first and second external terminals of the semiconductor integrated circuit device, wherein
the semiconductor integrated circuit device includes
the first and second external terminals to which the input voltage and a ground voltage are respectively applied,
first and second switches that are connected in series between the first and second external terminals and connected together at a node from which the output voltage is extracted,
a heat generation detector portion for detecting a monitored temperature, and
a drive circuit for performing on/off control of the first and second switches, and
when the monitored temperature reaches a first threshold temperature, both the first and second switches are turned off, and, when the monitored temperature reaches a second threshold temperature that is higher than the first threshold temperature, the first and second external terminals are short-circuited.

9. An electric appliance comprising:
a semiconductor integrated circuit device;
a motor that is driven according to an output signal of the semiconductor integrated circuit device; and
an overcurrent protection element externally connected to at least one of first and second external terminals of the semiconductor integrated circuit device, wherein
the semiconductor integrated circuit device includes
the first and second external terminals, each of which receives a corresponding one of two different potentials applied thereto,
first and second switches that are connected in series between the first and second external terminals and connected together at a node from which the output signal is extracted,
a heat generation detector portion for detecting a monitored temperature, and
a drive circuit for performing on/off control of the first and second switches, and
when the monitored temperature reaches a first threshold temperature, both the first and second switches are turned off, and, when the monitored temperature reaches a second threshold temperature that is higher than the first threshold temperature, the first and second external terminals are short-circuited.
